(19) United States
(12) Patent Application Publication
(10) Pub. No.: US 2017/0334618 A1
(43) Pub. Date: Nov. 23, 2017

(54) Beverage Identification Marker With Matching Wearable Identifiers

(71) Applicant: Kimberly C. Kranker, Medfield, MA (US)

(72) Inventor: Kimberly C. Kranker, Medfield, MA (US)

(21) Appl. No.: 15/670,909

(22) Filed: Aug. 7, 2017

Related U.S. Application Data
(63) Continuation-in-part of application No. 15/007,824, filed on Jan. 27, 2016.
(60) Provisional application No. 62/108,975, filed on Jan. 28, 2015.

(51) Int. Cl. B65D 51/24; G09F 3/00; G09F 3/02; G09F 23/08

(52) U.S. Cl. CPC B65D 51/245; G09F 23/08; G09F 3/005; G09F 3/02

(57) ABSTRACT

A beverage identification system includes a beverage identification marker and a wearable identifier paired to the beverage identification marker. The beverage identification marker and wearable identifier each include a same or similar visual marking, such as a pattern, a color, a shape, a size, a texture, a material, or a combination thereof.

### RELATED APPLICATION

This application is a continuation-in-part of U.S. application Ser. No. 15/007,824, filed Jan. 27, 2016, which claims the benefit of U.S. Provisional Application No. 62/108,975, filed on Jan. 28, 2015. The entire teachings of the above applications are incorporated herein by reference.

### BACKGROUND

Beverage identification markers are typically provided to place on individuals' beverage containers to identify and help differentiate one's beverage from another. This requires each individual to remember the specific markings that were assigned to their beverage container. There have been some attempts at making the identification of a container easier. For example, printable labels to identify a beverage container and special markers to write on a beverage container have been described. These inventions are cumbersome to use and still require individuals to remember some part of the design, or the beverage container identification is too easily removed.

### SUMMARY OF THE INVENTION

Described is a beverage identification system, which includes a beverage identification marker and a paired wearable identifier. A beverage identification marker attaches to a beverage container and a wearable identifier is worn on a person. The wearable identifier includes a visual marking that is the same or similar to a visual marking included on the beverage identification marker. The visual marking can be a pattern, color, shape, size, texture, material, or any combination thereof.

The combination of the beverage identification marker and the wearable identifier allows the individual to identify which beverage is theirs by simply matching their wearable identifier with that attached to the beverage container. The beverage identification system enables a person to locate their beverage container even if they have forgotten the appearance of their beverage marker.

Alternatively, a beverage identification system includes at least two pairs of identifiers, each pair of identifiers including a beverage identification marker and a wearable identifier, and each pair having a distinguishable appearance from each other pair of identifiers. The beverage identification marker of a pair can include a visual marking that is the same or similar to a visual marking included on the wearable identifier of the pair. Each pair includes a different visual marking from each other pair of identifiers.

A method of identifying a beverage includes placing a beverage identification marker on the beverage and wearing an identifier paired to the beverage identification marker. Wearing an identifier can include placing the identifier about a wrist or clipping the identifier to an article of clothing. Placing the identification marker includes securely attaching it to a beverage container.

A kit includes a package and at least two pairs of identifiers in the package, each pair of identifiers including a beverage identification marker and a wearable identifier. Each pair has a distinguishable appearance from each other pair of identifiers.

A wearable identifier and/or a beverage identification marker can be a flexible spring band, otherwise known as a slap band. Alternatively, a beverage identification marker and/or a wearable identifier can include a magnetic closure, such as magnetic pieces located on either end of an elongated portion of the beverage identification marker, such that the marker can be placed over the lip of a container or around a stem or handle of a container while remaining securely affixed, and/or around an article of clothing.

A method of identifying a beverage includes magnetically securing a beverage identification marker to a beverage container. The beverage identification marker includes an elongated portion located between a first magnetic piece and a second magnetic piece, the first magnetic piece located at an outer surface of the container and engaging with the second magnetic piece located at an inner surface of the container.

The elongated portion can be located over a lip of the container. The method can further include securing a wearable identifier to a person, the wearable identifier paired to the beverage identification marker. Securing the wearable identifier can include magnetically clasping the identifier to itself through or around an article of clothing or securing a slap band to the person.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates a beverage identification marker and a wearable identifier.

FIG. 2 illustrates the beverage identification marker of FIG. 1 with a second type of wearable identifier.

FIG. 3 illustrates a beverage identification marker on a different type of container and a wearable identifier.

FIG. 4 illustrates a beverage identification marker and a wearable identifier attached to a different clothing location.

FIG. 5 illustrates a set of beverage identification markers and wearable identifiers included in a package.

FIG. 6 illustrates another type of beverage identification with a wearable identifier.

FIG. 7 illustrates a beverage identification marker in a different location.

FIG. 8 illustrates several beverage identification markers on different types of containers.

### DETAILED DESCRIPTION OF THE INVENTION

A description of example embodiments of the invention follows.

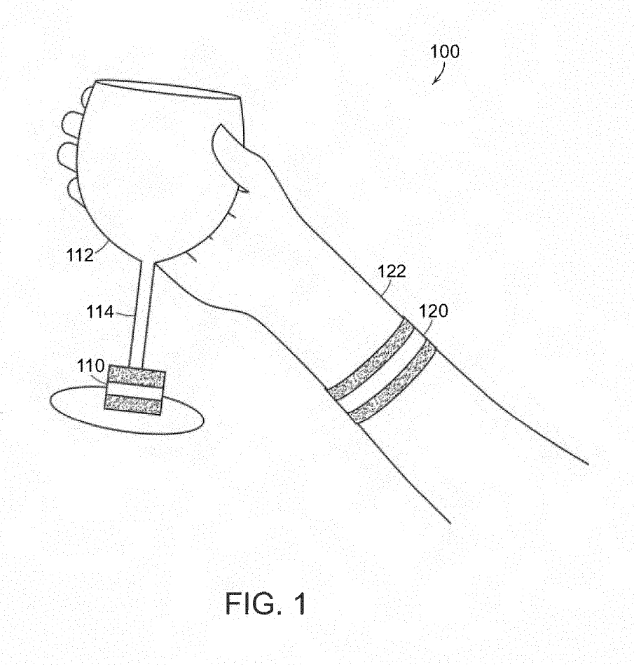

As shown in FIG. 1, a beverage identification system 100 includes a beverage identification marker 110 and a corresponding, matching wearable identifier 120. Beverage identification marker 110 is attached to a beverage container 112. In particular, beverage identification marker 110 is shown to circumscribe the stem 114 of a wine glass 112. Matching wearable identifier 120 is shown worn on a wrist 122. Beverage identification marker 110 and matching wearable identifier 120 can each incorporate a recognizable color or design that indicates that they are paired. For example, as shown in FIG. 1, beverage identification marker 110 and matching wearable identifier 120 each display a striped design.

A beverage identification marker can be, for example, a closed loop of material that can be placed around the stem of a wine glass by threading the material over the base of the wine glass. Alternatively, a beverage identification marker can be an open loop of material that can be fit directly over the stem of a wineglass, or a strip of material that can be wound about the stem of a wineglass and affixed to itself, such as through a hook and loop, snap, magnet, button, elastic, or tie closure. When attached, the beverage identification marker has a diameter that is smaller than that of the base of the wine glass and/or the bowl of the wine glass, allowing it to stay attached during normal movement of the drink. The beverage identification marker can be easily removed from the wine glass for reuse at a later time.

A matching wearable identifier can be, for example, a loop of material that can be worn on the body. As shown in FIG. 1, matching wearable identifier 120 is worn as a wristband. Alternatively, a matching wearable identifier can be worn as a ring, anklet, or necklace. A matching wearable identifier can also be formed from a strip of material that can be wound about the wrist, or another other body part, or an open loop of material, such as a bracelet cuff, that can be fit directly over the wrist. The wearable identifier can be attached to the person, their clothing, or any accessory of the person in a manner that allows normal movement, but is easily removed for reuse at a later time.

Beverage identification markers and wearable identifiers can be, for example, closed or open bands of elastic, silicon, or other, similar flexible material. Alternatively, beverage identification markers and wearable identifiers can be material, such as ribbon, layered over a flexible spring band, such as a slap bracelet or snap bracelet. Other materials that can be used to form beverage identification markers and/or wearable identifiers, either alone or layered over a flexible spring band, include leather, lace, cloth, felt and other fabrics.

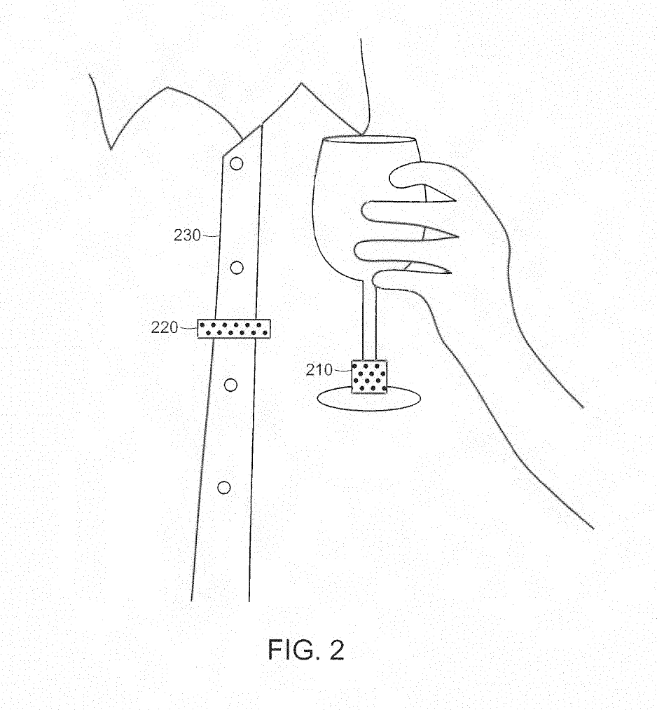

In an alternative configuration, as shown in FIG. 2, a wearable identifier 220 is worn on the placket 230 of a shirt and is paired with beverage identification marker 210. Wearable identifier 220 can be, for example, a clip, such as a tie clip, that can slide over and pinch tight against a clothing layer, allowing it to stay affixed to the clothing during normal movement. As shown in FIG. 2, wearable identifier 220 and beverage identification marker 210 are indicated as being paired by each having a similar or identical design, for example, a polka-dot pattern.

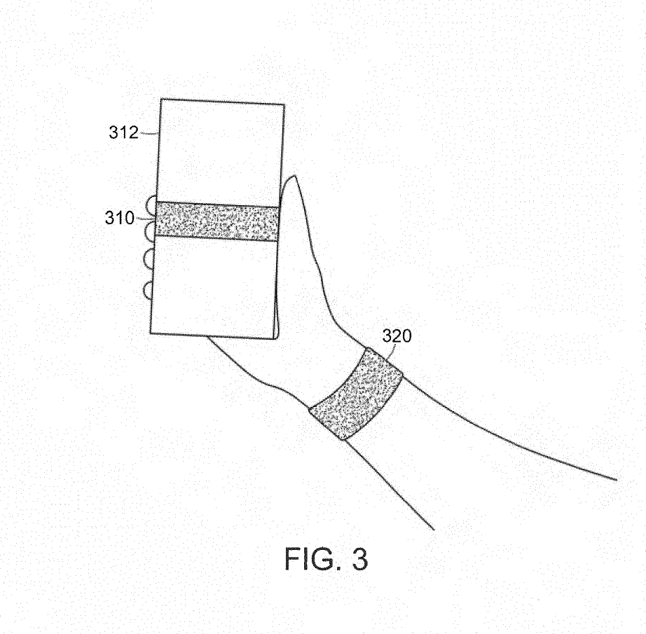

Beverage identification markers can conform to a variety of glass shapes and sizes. As shown in FIG. 3, a beverage identification marker 310 is attached to the walls of a cylindrical drinking glass 312. Beverage identification marker 310 can, for example, be a closed loop of material that is capable of staying affixed to the sides of the drinking glass, can, or bottle. Matching wearable identifier 320 is shown worn on the wrist, similar to wearable identifier 120 shown in FIG. 1. Beverage identification marker 310 and matching wearable identifier 320 are shown to be paired by having the same solid color. Beverage identification marker 310 and matching wearable identifier 320 can be similarly or identically sized bands of material, such that each band can be interchangeably worn on a body or on a beverage container. For example, beverage identification marker 310 and matching wearable identifier 320 can be identical bands of elastic material, or identical slap bracelets, which are capable of being worn both as a bracelet and of fitting around a drinking glass.

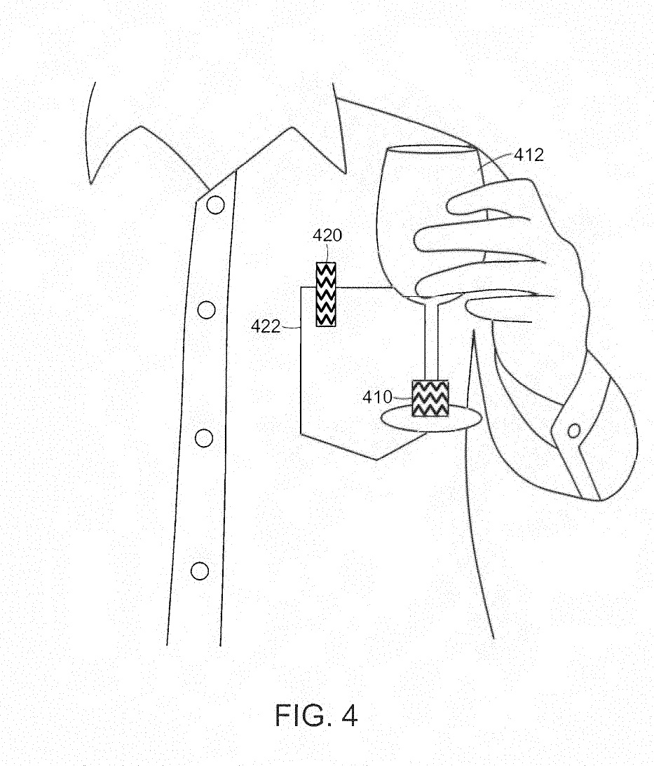

Wearable identifiers can also apply to a variety of different clothing types or at a variety of clothing locations. As shown in FIG. 4, a wearable identifier 420 is shown affixed to the pocket 422 of a shirt. Wearable identifier 420 can be a clip, such as that described with respect to wearable identifier 220. Wearable identifiers in a clip configuration can be worn on shirt plackets (as shown in FIG. 2), on shirt pockets (as shown in FIG. 4), on other shirt locations including cuffs, collars, and lapels, or on other articles of clothing, such as belts, belt loops, sneaker lacings, ankle straps, pant hems, and the like. Matching beverage identification marker 410 is shown affixed to the stem of a wine glass. Beverage identification marker 410 and matching wearable identifier 420 are shown to be paired by each including a matching design, for example, a chevron pattern.

The visual matching of a beverage identification marker to a wearable identifier can be accomplished by incorporating the same pattern, color, shape, size, texture, material, or any combination thereof in both the beverage marker and the wearable identifier. The distinct markings of an identification pair (a beverage marker and a wearable identifier), serve as a visual cue for a person to identify his or her beverage container from the beverage container(s) of another.

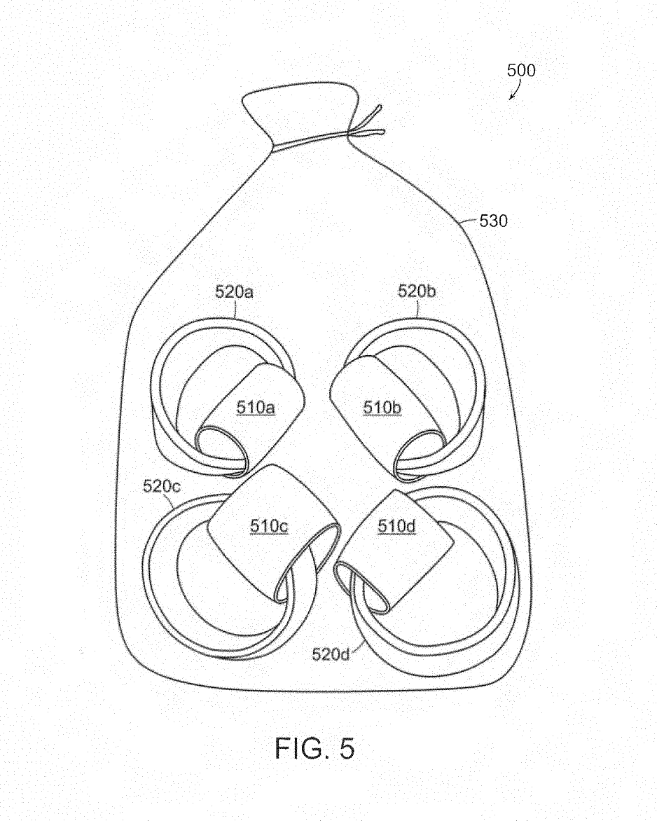

A beverage identification system can include multiple sets of paired beverage identification markers and matching wearable identifiers, with each pair incorporating a distinct pattern, color, shape, size, texture, material, or any combination thereof from the other pairs in the set. For example, a beverage identification system 500 is shown in FIG. 5. The system 500 includes four sets of markers and identifiers, with each beverage identification marker 510a, 510b, 510c, 510d linked together with a matching wearable identifier 520a, 520b, 520c, 520d. The marker and identifier sets are contained within a package 530, such as a bag or other container. While beverage identification system 500 is shown as having four sets of marker and identifier pairs, any number of marker and identifier sets can be included. For example, a beverage identification system can include 2, 3, 4, 5, 6, 8, 10, 12, or 20 marker and identifier sets.

Additionally, while sets are shown in FIG. 5 to include one wearable identifier paired to each beverage identification marker, a set can include multiple types of wearable identifiers paired to one beverage identification marker. For example, a set can include both a clip-type wearable identifier, such as wearable identifier 220 (FIG. 2), and a bracelet-type wearable identifier, such as wearable identifier 120 (FIG. 1), with both identifiers matching one beverage identification marker, thereby providing an individual with an option as to what type of identifier to wear for a corresponding marker. Alternatively, or in addition, multiple types of beverage identification markers can be included. For example, a set can include a wine glass-type beverage identification marker, such as marker 110 (FIG. 1), and a can-type beverage identification marker, such as marker 310 (FIG. 3), with both markers matching a wearable identifier.

The beverage identification markers and wearable identifiers can be used at gatherings where two or more people are using similar beverage containers and there is a need to differentiate between their containers.

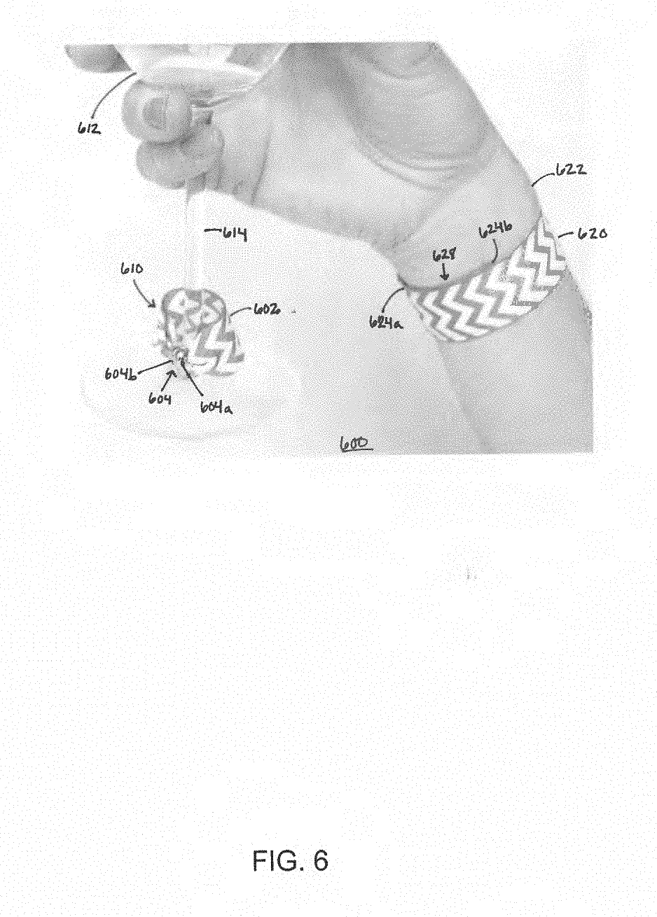

A beverage identification system having a different type of beverage identification marker is shown in FIG. 6. In beverage identification system 600, beverage identification marker 610 includes an elongated portion 602 that can engage with itself at its ends with a closure 604. As illustrated, closure 604 comprises magnetic pieces 604a, 604b, which attract and join with each other. As such, magnetic pieces 604a, 604b can engage and disengage to allow for wrapping of the elongated portion 602 around a stem 614 of a wineglass.

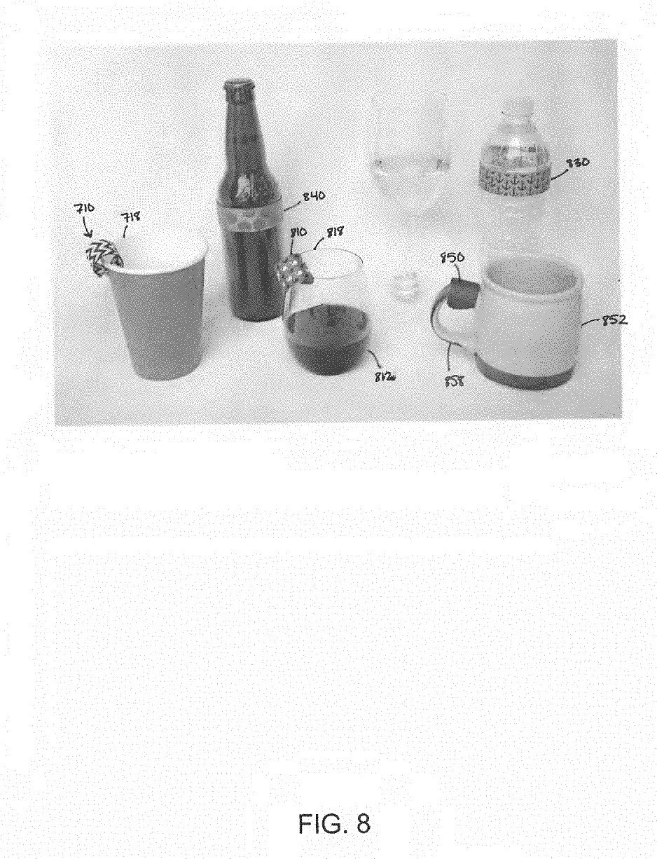

A corresponding wearable identifier 620 is also included, which, as shown, is formed from a flexible spring band, alternatively referred to as a slap band, and placed about a wrist 622. Slap bands can be formed from bistable metal spring bands, which can be covered by one or more layers of fabric, silicone, rubber, or plastic. Slap bands can accommodate wrists or other appendages of varying sizes by adjusting to different circumferences in a coiled state. For example, as shown in FIG. 6, slap band 620, applied to wrist 622, has a region 628 in which the band overlaps with itself, as is visible with ends 624a, 624b being located some distance away from one another. On a person with a smaller wrist, region 628 may be longer, and on a person with a larger wrist, region 628 may be shorter or nonexistent. Wearable identifier 620 can also, in an alternative arrangement, be used as a beverage identification marker. For example, a slap band can be placed about a bottle (FIG. 8).

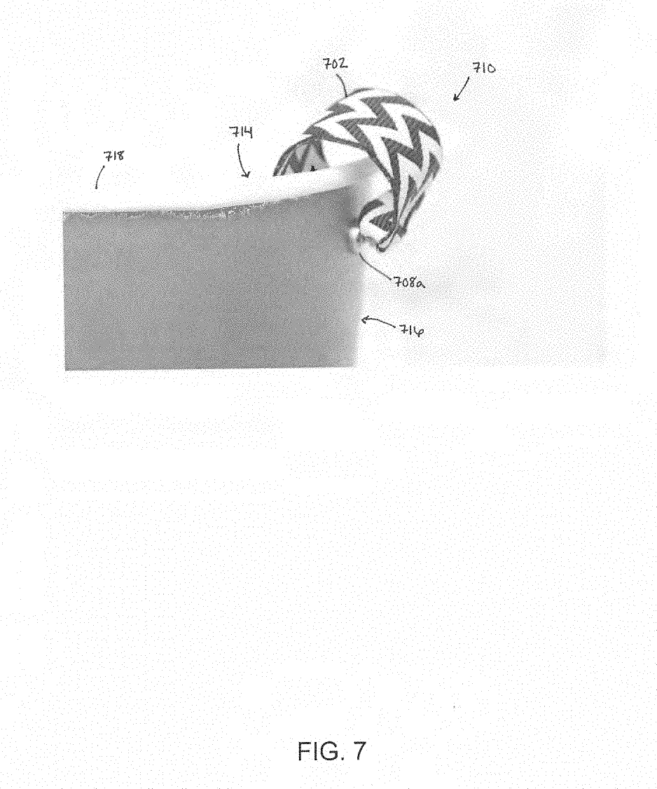

Beverage identification markers having magnetic closures, such as marker 610, can advantageously be placed on a beverage in a greater number of configurations than simple elastic bands or simple thin metal hoops. As shown in FIG. 7, beverage identification marker 710 is placed over a lip 718 of a cup. In particular, elongated portion 702 spans over the lip 718 and remains securely in place by magnetic piece 708a engaging with a corresponding magnetic piece located inside the cup (not shown in FIG. 7). In particular, magnetic piece 708a is placed against an outer surface 716 of the cup, while the corresponding magnetic piece (not shown) is placed against an inner surface 714 of the cup. The magnetic pieces can remain engaged with each other through the material of the beverage container, such as glass, plastic, or paper. As the magnetic pieces can also engage through cloth, a beverage identification marker, such as marker 610, and also be a wearable identifier. For example, marker 610 can be applied to clothing, attaching to itself through the cloth of a shirt pocket, shirt placket, collar, neckline, or pinched fabric. Alternative, marker 610 can be worn through a button hole, around a belt loop, or around another wearable accessory, such as a necklace, bracelet, or watch. The marker 610 can also be worn directly on a person, such as placed around a finger, like a ring.

Elongated portion 702 can be formed from any flexible material, such as fabric, silicone, rubber, or plastic. Elongated portion 702 can alternatively be formed from a resilient, flexible wire or wire frame that is covered in a material, such as fabric, silicone, rubber, or plastic. A frame of resilient material that elastically returns to the closed loop form supports the action of the magnets, allowing for use of weaker magnets or even a single magnet that attracts an opposed metal piece.

A drawback of elastic bands as beverage identification markers is that they must be sized appropriately for an intended type of container. If the elastic band is too small, it will be difficult to apply and remove from the container. If the elastic band is too large, it will not remain securely affixed to the container. Similarly, the thin metal open hoops of conventional wine charms are limited to use with wine stems. In contrast, beverage identification markers, such as markers 610, 710 are able to remain securely attached to a wide variety of beverage containers, as shown in FIG. 8. For example containers that are otherwise unable to accept either an elastic band or a conventional wine charm, such as stemless wineglass 812, which does not have a stem around which a conventional metal hoop wine charm can be placed and which has a curved outer shape on which an elastic band is likely to roll off, can have a beverage identification marker 810 placed over its rim 818 and remain securely attached by a magnetic clasp. Such beverage identification markers can also be placed around handles. For example, as shown in FIG. 8, beverage identification marker 850 having a magnetic clasp (not shown) can be placed about a handle 858 of a mug 852.

In addition, as shown in FIG. 8, slap band beverage identification markers 830, 840 are able to accommodate bottles of varying sizes. As described above, elastic bands must be sized appropriately for an intended type of container. In contrast, slap bands can remain secured to a bottle in their coiled state over a greater range of circumferences than an elastic band.

While this invention has been particularly shown and described with references to example embodiments thereof, it will be understood by those skilled in the art that various changes in form and details may be made therein without departing from the scope of the invention encompassed by the appended claims.

What is claimed is:

1. A beverage identification system, comprising:
a beverage identification marker; and
a wearable identifier paired to the beverage identification marker.

2. The beverage identification system of claim 1, wherein the wearable identifier includes a visual marking that is the same or similar to a visual marking included on the beverage identification marker.

3. The beverage identification system of claim 2, wherein the visual marking is at least one of a pattern, a color, a shape, a size, a material, and a texture.

4. The beverage identification system of claim 2, wherein the visual marking is at least two of a pattern, a color, a shape, a size, a material, and a texture.

5. The beverage identification system of claim 1, wherein the wearable identifier is a slap band.

6. The beverage identification system of claim 1, wherein the beverage identification marker is a slap band.

7. The beverage identification system of claim 1, wherein the wearable identifier includes a magnetic closure.

8. The beverage identification system of claim 1, wherein the beverage identification marker includes a magnetic closure.

9. A beverage identification system, comprising:
at least two pairs of identifiers, each pair of identifiers including a beverage identification marker and a wearable identifier, and each pair having a distinguishable appearance from each other pair of identifiers.

10. The beverage identification system of claim 9, wherein the beverage identification marker of a pair includes a visual marking that is the same or similar to a visual marking included on the wearable identifier of the pair, and wherein each pair includes a different visual marking from each other pair of identifiers.

11. The beverage identification system of claim 9, wherein at least one of the wearable identifiers is a slap band.

12. The beverage identification system of claim 9, wherein at least one of the beverage identification markers is a slap band.

13. The beverage identification system of claim 9, wherein at least one of the wearable identifiers includes a magnetic closure.

14. The beverage identification system of claim 9, wherein at least one of the beverage identification markers includes a magnetic closure.

15. A method of identifying a beverage comprising:
magnetically securing a beverage identification marker to a beverage container, the beverage identification marker including an elongated portion located between a first magnetic piece and a second magnetic piece, the first magnetic piece located at an outer surface of the container and engaging with the second magnetic piece located at an inner surface of the container.

16. The method of claim 15, wherein the elongated portion is located over a lip of the container.

17. The method of claim 15, further comprising securing a wearable identifier to a person, the wearable identifier paired to the beverage identification marker.

18. The method of claim 17, wherein the wearable identifier includes a visual marking that is the same or similar to a visual marking included on the beverage identification marker.

19. The method of claim 17, wherein securing the wearable identifier includes magnetically clasping the identifier to itself through or around an article of clothing.

20. The method of claim 17, wherein securing the wearable identifier includes securing a slap band to the person.
